(19) United States
(12) Patent Application Publication
(10) Pub. No.: US 2016/0300253 A1
(43) Pub. Date: Oct. 13, 2016

(54) METHOD FOR IMPROVING COMPUTING EFFICIENCY IN AWARDING EQUITY REWARDS FROM SOCIAL ACTIVITY IN A VIRTUAL SOCIAL MEDIA PLATFORM

(71) Applicant: Kenneth Scott Kaufman, Carlsbad, CA (US)

(72) Inventor: Kenneth Scott Kaufman, Carlsbad, CA (US)

(21) Appl. No.: 14/684,301

(22) Filed: Apr. 10, 2015

(51) Int. Cl. G06Q 30/02; G06Q 50/00; H04L 29/08

(52) U.S. Cl. CPC G06Q 30/0214; H04L 67/306; H04L 67/10; G06Q 50/01

(57) ABSTRACT

A method for awarding equity rewards from social activity in a virtual social media platform enables the administrator of a social media platform to reward members of the social media platform with equity ownership based on the member's actions, activity and ability to attract other to the network. The method for awarding equity rewards from social activity in a virtual social media platform employs an activity monitor module that monitors the social media network for social actions performed by users, a points assignment module that assigns equity points to a user's account in response to that user's social activity on the network, a tracking for storing all social actions performed on the network and equity points assigned to users, and a points redemption module that facilitates the redemption of equity points for shares of equity in the social media platform.

### BRIEF DESCRIPTION OF THE DRAWINGS

FIG. 1 shows a block diagram of the operations modules of a method for improving computing efficiency in awarding equity rewards from social activity in a virtual social media platform in accordance with the present invention

FIG. 2 shows a block diagram of a downstream user matrix of a method for improving computing efficiency in awarding equity rewards from social activity in a virtual social media platform in accordance with the present invention.

FIG. 3 shows a flow chart of a points assignment process in a method for improving computing efficiency in awarding equity rewards from social activity in a virtual social media platform in accordance with the present invention.

FIG. 4 shows a flow chart of a points redemption process in a method for improving computing efficiency in awarding equity rewards from social activity in a virtual social media platform in accordance with the present invention.

### DETAILED DESCRIPTION OF THE INVENTION

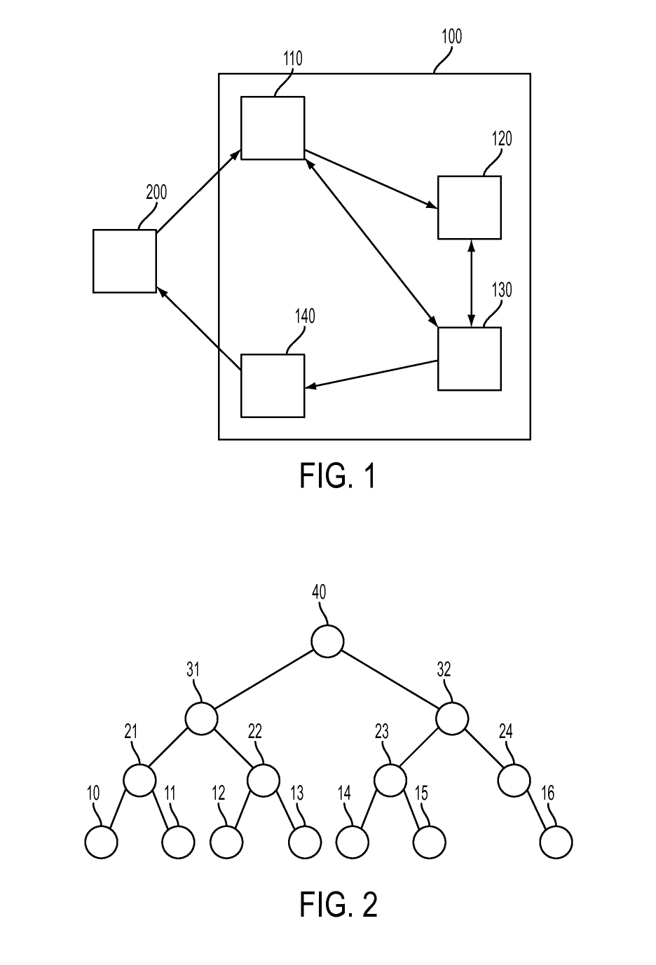

Referring now to the drawings and in particular FIG. 1, a method for improving computing efficiency in awarding equity rewards from social activity in a virtual social media platform enables the administrator of a social media platform to reward members of the social media platform with equity ownership based on the member's actions, activity and ability to attract others to the network. References to a social media platform herein pertain to network based services that allow people to create, share or exchange information, ideas, and pictures/videos in virtual communities and networks. Various operations of an exemplary social media platform are described in Applicant's U.S. concurrently filed U.S. patent application Ser. No. 14/673,871 (“Exemplary Platform”), the disclosure of which is hereby incorporated by reference in its entirety. It is appreciated, however, that the instant invention may be applied to improve the efficiency and reduce the data processing, transmission and storage demands of assigning equity awards in any conventional social media platform.

The method for improving computing efficiency in awarding equity rewards from social activity in a virtual social media platform employs an activity monitor module 110 that monitors the social media network for social actions performed by users, a points assignment module 120 that assigns equity points to a user's account in response to that user's social activity on the network, a tracking module 130, defined as a relational database in the preferred embodiment, for storing all social actions performed on the network and equity points assigned to users, and a points redemption module 140 that facilitates the redemption of equity points for shares of equity in the social media platform. It is contemplated that these components are embodied in one or more computer programs defining a set of instructions that, when executed by one or more computer processors, cause the processor(s) to perform their functions. In the preferred embodiment, this computer program(s) is stored on a non-transitory medium and operates on a computer system 100 having one or more processor units in communication with the non-transitory medium. It is specifically contemplated that the computer program(s) may be stored on and/or operated from cloud based servers and through mobile computer devices.

In the illustrated embodiment, the computer program(s) embodying the method for awarding equity rewards from social activity in a virtual social media platform is housed on a discrete computer system(s) 100 in networked communication with the server 200 (or computer system) as the operating software of the social media platform, thereby allowing the server to provide cloud computing services to computer systems(s) 100, such as mobile computers (i.e. smartphones, tablets), while utilizing the computer program(s). It is contemplated, however, that in alternate embodiments, some or all of the computer program(s) may be housed on the same server on which the operating software is executed.

As it is appreciated that social media platform's rely on the activity of a network of users (or members) to prosper and sustain themselves, it is understood that methods directed at increasing or incentivizing user's social activity on the platform would essentially serve to promote the prosperity of the social media platform itself.

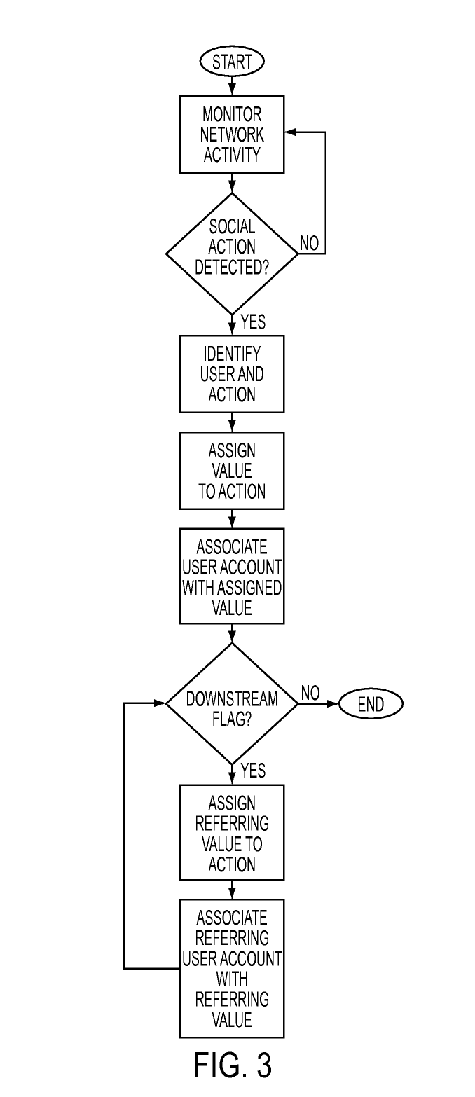

Referring now to FIGS. 2 and 3, a points assignment process underlies the method for awarding equity rewards from social activity in a virtual social media platform, introducing a gamification component that rewards social actions on the platform to leverage the natural desire of a social media platform user to socialize in order to increase user engagement. The activity monitor module interfaces directly with the social media platform operating software to (1) associate new registered users with a referral user, if any, and (2) detect social actions performed by registered users.

To associate new registered users with referral users, the activity monitor periodically queries the social media platform operating software for the new registrations. If there are any new registrations since the last new registration query, for each new registration, the activity monitor queries the social media platform operating software to determine if the new registration was (1) directly or indirectly initiated by or (2) included a flag that indicated it was the result of a referral of an existing registered user. If the activity monitor determines the new registration was the result of a referral, the activity monitor transmits to the tracking module electronic data specifying the referring registered user account and the downstream registered user account. The tracking module, which stores each registered user account in a separate database entry, processes this referring user account data by including in the referring registered user account entry a referral flag identifying the downstream registered user account and including in the downstream registered user account entry a downstream flag identifying the referring registered user account.

The activity monitor additionally detects each social action performed by a registered user on the social media platform with which the method for awarding equity rewards from social activity operates in conjunction through its interface with the social media platform operating software. It is contemplated that the activity monitor module will detect all social actions available on the relevant social media platform, which will commonly include actions such as publishing a post, viewing of posts, commenting on posts, forwarding of posts, the liking of posts, the disliking of posts, and spamming posts. It is contemplated that posts may refer to conventional social media platform activity, such as messages or multimedia content (whether created by the user or simply uploaded or linked by the user), performed by a registered user through the social media platform. When such a social action is detected, the activity monitor module prompts the points assignment module to begin the evaluation of the social action for the awarding of equity points therefor.

When receiving a prompt from the activity monitor module for a detected social action, the points assignment module retrieves identifying information related to the detected social action. In the preferred embodiment, such identifying information includes the identity of the user account of the registered user performing the social action and the type of social action detected. Once the identifying information is retrieved, the points assignment module performs a weighing routine that assigns a value of equity points to the social action. In the preferred embodiment, the weighing routine assigns a high value the publication of posts and commenting on posts, a moderate value for the forwarding of posts, and a low value for viewing posts, the liking of posts, the disliking of posts, and spamming posts. It is understood, however, that the weighing routine can be configured to weigh social actions in alternate manners by an administrator of the social media platform by assigning different values to the social actions as desired by the administrator.

Once the social action has been valued, the equity points assigned thereto are associated to the user account that performed the social action. The points assignment module then transmits the electronic data specifying the user account and the equity point amount to the tracking module for storage in a rewards database, thereby enabling the tracking of accumulated equity points by user account.

Next, the points assignment module queries the tracking module to determine if there are any downstream flags associated with the user account to which it just assigned equity points. If not, the points assignment module terminates the points assignment process for that user account. If so, the points assignment module assigns an amount of equity points that corresponds to the equity points just assigned to the referring registered user account. In one embodiment, the referring registered user account receives a fraction of the equity points, while in other embodiments, the referring registered user account receives an equal amount or an amount determined by some other assignment of points to action methodology. The points assignment module then repeats this query and action until there are no downstream flags in the user account to which it just assigned equity points. As illustrated by FIG. 2, this process enables the points assignment module to assign equity points upstream through a hierarchical chain from any one of a furthest downstream user 10, 11, 12, 13, 14, 15, 16 through any number of respective referring users 21, 22, 23, 24 of the furthest downstream user 10, 11, 12, 13, 14, 15, 16, through any number of respective referring users 31, 32 to an originating user 40.

Through the performance of assigning equity points to social actions and associating them with the relevant user accounts in real time in accordance with the present invention enables significant improvements in execution time and reductions in the amount of data that must be transmitted relative to performing a periodic assignment of the same based on historical data accumulated over set time interval for accomplishing the same action. For example, when the instant invention is employed to assign equity points for activity in the Exemplary Platform, an average reduction in client execution time of 2.4% has been observed, an average reduction in bytes sent from the client (to the server) of 49.4% has been observed, an average reduction in total execution time of 90.4% has been observed, and an average reduction in wait time on server replies of 97.0% has been observed.

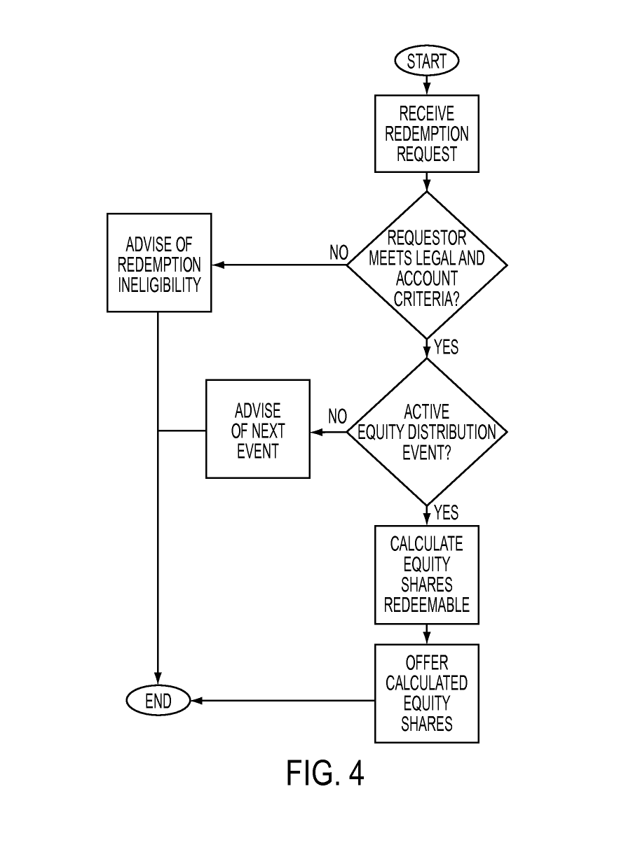

Referring now to FIG. 4, while the points assignment module is operative to facilitate the accumulation of equity points, the redemption of points by a registered user redeems points for equity or an ownership share in the entity operating or associated with the social media platform is controlled through the points redemption module. The points redemption process through the points redemption module begins with the receipt of a redemption request. While redemption requests are typically initiated by registered users, it is contemplated that redemption requests may also or alternatively be initiated by the administrator of the social media platform.

Once a redemption request is received, the points redemption module retrieves from the tracking module identifying information for the person to whom the registered user account that initiated the request or that is otherwise the subject of the request belongs. This identifying information is then used to confirm the person to whom subject user account belongs meets the legal qualifications for acquiring stock in the subject entity as well as the account profile requirements. The legal qualifications may vary by relevant jurisdiction, but typically include confirming the person to whom subject user account belongs is of legal age and is otherwise eligible by law to own stock in the subject entity. The account profile requirements are defined by the administrator of the social media platform and often define a percentage of members eligible for redeeming points for equity shares. If the person does not meet these qualifications and requirements, the points redemption module issues a notice that the user account is not eligible to redeem equity points for ownership and the points redemption module terminates. In alternate embodiments, the points redemption module may provide an alternate reward for the redemption of equity points.

If the person meets the legal qualifications and profile requirements, the points redemption module determines if there is an active equity distribution event. If there is no ongoing equity distribution event, the points redemption module generates a message advising of the next event and invites the user to re-initiate a redemption request then. If there is an ongoing equity distribution event at present, the points redemption module generates a calculation of equity shares that may be redeemed based on the number of equity points associated with the user's account and the administrator set parameters for the equity distribution event (such as a percentage of equity pool available as a ratio to the percentage of outstanding equity points). The user can then accept the calculated equity share offer, thereby acquiring the calculated ownership percentage, or reject the calculated offer, banking the equity points to be redeemed later.

The present invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method for improving the computing efficiency of awarding equity rewards from social activity in a virtual social media platform, comprising the steps of:
providing a computer system connected to at least one electronic communication network and having one or more processor units and non-transitory computer-readable medium in communication with the one or more processor unit, wherein said medium having one or more computer programs stored thereon which include a set of instructions executable by one or more processor units;
monitoring by said processor network activity on a social media platform;
upon detecting a social actions by a registered user of the social media platform, retrieving by said processor identifying information related to the detected social action, wherein such identifying information includes at least the identity of the user account of the registered user performing the social action and the type of social action detected;
assigning by said processor a value of points to the social action, wherein said value of points correlates to the type of social action;
associating by said processor the assigned value of points to the identified user account;
notating by said processor a referral registered user, wherein a referral registered user defines the registered user that referred the identified user account's registered user;
if notating the referral user account, assigning by said processor at least one value of referral points to the social action; and
if assigning at least one value of referral points, associating by said processor the at least one assigned value of referral points to the user account of the referral registered user.

2. The method of claim 1, wherein said step of notating includes notating any reference user account upstream through a hierarchical chain of the identified user account and the user account of the referral registered user.

3. The method of claim 2, wherein said step of notating includes associating the at least one assigned value of referral points to at least one reference user account.

4. The method of claim 2, wherein said step of notating includes associating the at least one assigned value of referral points to each reference user account.

5. The method of claim 1, wherein said points define equity points exchangeable for equity shares in an entity which operates the social media platform.

6. The method of claim 1, additionally comprising:
receiving by said processor a redemption request associated with a requesting registered user of the social media platform;
validating by said processor the eligibility of the requesting registered user to redeem points for a reward;
identifying an equity distribution event; and
if the equity distribution event is ongoing, calculating equity shares redeemable by the requesting registered user based on the number of points associated with the user's account.

7. The method of claim 6, wherein said redemption request is initiated by the registered user.

8. The method of claim 6, wherein said redemption request is initiated by an administrator of the social media platform.
